(19) United States
(12) Patent Application Publication
(10) Pub. No.: US 2022/0185707 A1
(43) Pub. Date: Jun. 16, 2022

(54) VOLTAGE REGULATED WATER PURIFICATION METHODS AND SYSTEMS

(71) Applicant: Mark Franklin, Phoenix, AZ (US)

(72) Inventor: Mark Franklin, Phoenix, AZ (US)

(21) Appl. No.: 17/438,643

(22) PCT Filed: Jun. 13, 2019
(86) PCT No.: PCT/US2019/036961

§ 371 Date: Sep. 13, 2021

Related U.S. Application Data
(60) Provisional application No. 62/817,736, filed on Mar. 13, 2019.

(51) Int. Cl. C02F 1/463; C02F 1/461; C02F 1/24

(52) U.S. Cl. CPC C02F 1/463; C02F 2101/20; C02F 1/24; C02F 1/46109

(57) ABSTRACT

Voltage regulated electrolytic water purification methods and systems are provided. The methods and systems utilize a series of deflocculation tanks each containing a series of electrodes and a bubbler to remove contaminants from water. The water purification methods and systems increase the life of the electrodes, allowing for reduced maintenance.

### FIELD

The present disclosure relates to voltage regulated water purification methods and systems.

### BACKGROUND

Pollutants, particularly heavy metals can be removed from contaminated water using electrolysis. Specifically, electrically active metal plates are used to trigger chemical reactions, which cause undesirable components to coagulate, flocculate, or precipitate out from the water so that they can be more easily removed.

The metal plates typically comprise one or more anodes or cathodes. In some cases, an array or series of charged chemical plates is used. As with any electrochemical system, electrons flow across a voltage drop, i.e., from anode to cathode while positive ions flow in the other direction, i.e., from cathode to anode. This can be an issue because over time the positive ions form scale deposits on the anode, leading to losses of efficiency and equipment life.

In addition, current water purification systems mostly target the removal of heavy metals and do not adequately remove other non-heavy metal contaminants.

Therefore, what is needed are methods and systems of water purification having increased efficiency, increased equipment life, and improved removal of non-heavy metal contaminants.

### SUMMARY

Covered embodiments are defined by the claims, not this summary. This summary is a high-level overview of various aspects and introduces some of the concepts that are further described in the Detailed Description section below. This summary is not intended to identify key or essential features of the claimed subject matter, nor is the summary intended to be used in isolation to determine the scope of the claimed subject matter. The subject matter should be understood by reference to appropriate portions of the entire specification, any or all drawings, and each claim.

Some embodiments of the present disclosure relate to a method comprising: obtaining water, the water comprising one or more contaminants; flowing the water from an inlet into a first deflocculation tank, the first deflocculation tank comprising: a first series of electrodes; and a first bubbler; generating flocculating metal ions from at least one metal contaminant with a regulated power supply by: applying, with a regulated power supply, at least one electric potential to the first series of electrodes; and varying, with a control system, the at least one electric potential to provide a predetermined fixed current to the first deflocculation tank, wherein the predetermined fixed current does not vary as a function of flow rate; collecting the flocculated metal ions from the first deflocculation tank, so as to obtain deflocculated water; flowing the deflocculated water into at least one sparging tank, wherein the at least one sparging tank comprises a sparger; removing, with the sparger, at least one non-metal contaminant from the deflocculated water to obtain treated water; and flowing the treated water into an outlet.

Some embodiments of the present disclosure relate to a system comprising an inlet; a first deflocculation tank, the first deflocculation tank comprising: a first series of electrodes; and a first bubbler; a regulated power supply; wherein the regulated power supply is configured to generate flocculating metal ions; wherein the regulated power supply is further configured to apply at least one electric potential to the first series of electrodes; a control system, wherein the control system is configured to vary the at least one electric potential to provide a predetermined fixed current to the first deflocculation tank, wherein the predetermined fixed current does not vary as a function of flow rate; at least one sparging tank comprising a sparger; and an outlet.

Some embodiments include flowing the water from the second deflocculation tank into a third deflocculation tank, wherein the third deflocculation tank is disposed between the second deflocculation tank and the at least one sparging tank; wherein the third deflocculation tank comprises a third series of electrodes, and a third bubbler; generating flocculating metal ions with a regulated power supply by: applying, with the regulated power supply, at least one electric potential to at least one of: the first series of electrodes, the second series of electrodes, or the third series of electrodes; varying, with a control system, the at least one electric potential to provide a predetermined fixed current to at least one of: the first deflocculation tank, the second deflocculation tank, or the third deflocculation tank; collecting the flocculated metal ions from at least one of: the first deflocculation tank, the second deflocculation tank, or the third deflocculation tank, so as to obtain deflocculated water.

Some embodiments include expelling, with the first bubbler, one or more cleaning agents into the water, wherein the one or more cleaning agents comprise at least one of: chlorine gas, oxygen gas, carbon dioxide gas, ammonia gas, nitrogen trifluoride gas, or combinations thereof.

Some embodiments include forming a plurality of bubbles with the one or more cleaning agents.

In some embodiments, each series of electrodes comprises an odd number of electrodes.

In some embodiments, a first electrode of each series of electrodes is a cathode and a last electrode of each series of electrodes is a cathode.

In some embodiments, a second electrode of each series of electrodes is an anode and a second to last electrode of each series of electrodes is an anode.

In some embodiments, a third electrode of each series of electrodes is a cathode and a third to last electrode of each series of electrodes is a cathode.

In some embodiments, each series of electrodes comprises an anode comprising at least one of: bare aluminum, anodized aluminum, rutile titanium(IV) oxide coated aluminum, aluminum (III) oxide coated aluminum, or combinations thereof.

In some embodiments, each series of electrodes comprises a cathode comprising at least one of: chromate replacement aluminum, oxygen treated rutile titanium (IV) coated aluminum, hot rolled aluminum, or combinations thereof.

In some embodiments, the first electrode is a cathode and is connected to a first voltage source, the second electrode is an anode and is grounded, the third electrode is a cathode and is connected to a second voltage source, the third to last electrode is a cathode and is connected to the first voltage source, the second to last electrode is an anode and is grounded, and the last electrode is a cathode and is connected to the second voltage source.

In some embodiments, the first electrode is a cathode and is grounded, the second electrode is an anode and is connected to a first voltage source, the third electrode is a cathode and is grounded, the third to last electrode is a cathode and is grounded, the second to last electrode is an anode and is connected to the first voltage source, and the last electrode is a cathode and is grounded.

In some embodiments, the first electrode is a cathode and is connected to a first voltage source, the second electrode is an anode and is grounded, the third electrode is a cathode and is connected to the first voltage source, the third to last electrode is a cathode and is connected to the first voltage source, the second to last electrode is an anode and is grounded, and the last electrode is a cathode and is connected to the first voltage source.

In some embodiments, each series of electrodes is an alternating series of electrodes in a triode configuration, wherein the triode configuration comprises one or more discrete subunits, wherein each of the one or more discrete subunits has the following configuration: cathode, anode, cathode.

In some embodiments, the triode configuration comprises a plurality of discrete subunits, such that the alternating series of electrodes within the triode configuration is arranged as follows: cathode, anode, cathode . . . cathode, anode, cathode.

In some embodiments, there are from 33 to 165 discrete subunits.

In some embodiments, the predetermined fixed current ranges from 50 to 160 amps of direct current.

In some embodiments, the sparger is a gas phase treatment sparger comprising a first proximal end immersed in the water in the at least one sparging tank and a second distal end connected to a vacuum source.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts an exemplary method and system in accordance with the present disclosure.

FIG. 2 depicts an exemplary series of electrodes in accordance with the present disclosure.

FIG. 3 depicts an exemplary bubbler, sparger, and vacuum in accordance with the present disclosure.

FIG. 4A depicts a circuit diagram showing a first exemplary configuration of electrodes in accordance with the present disclosure.

FIG. 4B depicts a circuit diagram showing a second exemplary configuration of electrodes in accordance with the present disclosure.

FIG. 4C depicts a circuit diagram showing a third exemplary configuration of electrodes in accordance with the present disclosure.

FIG. 5 depicts an exemplary bubbler assembly in accordance with the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the disclosure may be readily combined, without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Certain embodiments of the present disclosure relate to methods of purifying water. In addition, certain embodiments of the present disclosure relate to systems for purifying water.

As used herein the term “sparging” or gas flushing, is a method to remove low-boiling liquids from a solution. The low-boiling components tend to evaporate more rapidly, hence they may be removed from the bulk solution containing higher-boiling components. Sparging can be an alternative to distillation, and it does not require heat. Sparging can also involve bubbling a gas, such as nitrogen, argon, Oxygen, Chlorine, Florine, or helium, through a liquid. This can be used to remove dissolved gases (e.g., oxygen) from a liquid. As used herein, the term “sparger” is used to refer to a device or mechanism for removing non-metal contaminants from water (e.g., by way of a pressure differential between the water and the sparger).

As used herein, the term “bubbler” refers to the devices located in each deflocculation tank, which are devices and mechanisms for bubble gasses through contaminated water, so as to remove one or more metal contaminants from water (e.g., by utilizing the bubbles to carry flocculating metal ions to an upper portion of each deflocculation tank).

As used herein, the term “triode configuration” refers to a configuration of electrodes that is comprised of one or more subunits, with each subunit containing three electrodes.

The percentage reduction of each contaminant is measured as follows: 100×(([inlet concentration]−[outlet concentration])/[inlet concentration]).

As used herein, the term “voltage limited current” is a current that provide a predetermined charge per unit of electric potential applied to the system. A voltage limited currents differs from a flow rate limited current, which provides a predetermined charge per unit volume of water being treated.

In some embodiments water comprising one or more contaminants are obtained and fed into an inlet. Non-limiting examples of non-metal contaminants that can be present in the water include at least one of: Ammonia, Biochemical Oxygen, Carbonaceous Biochemical Oxygen, Chemical Oxygen, Phosphorus, Unionized Ammonia, or Boron.

Non-limiting examples of metal contaminants that can be present in the water include at least one of: Arsenic, Beryllium, Bismuth, Cadmium, Calcium, Chromium, Copper, Iron, Lead, Magnesium, Manganese, Potassium, Rubidium, Selenium, Silicon, Silver, Strontium, Sulfur, Tellurium, Thorium, Tin, Titanium, Tungsten, Uranium, Vanadium, Zinc, or Zirconium.

In some embodiments, the methods and systems described herein provide a percentage reduction of at least one contaminant described herein in an amount ranging from 4% to 99.9% In some embodiments, the methods and systems described herein provide a percentage reduction of at least one contaminant described herein in an amount ranging from 10 to 99.9%. In some embodiments, the methods and systems described herein provide a percentage reduction of at least one contaminant described herein in an amount ranging from 25 to 99.9%. In some embodiments, the methods and systems described herein provide a percentage reduction of at least one contaminant described herein in an amount ranging from 50 to 99.9%. In some embodiments, the methods and systems described herein provide a percentage reduction of at least one contaminant described herein in an amount ranging from 75 to 99.9%.

In some embodiments, the flow rate through the inlet ranges from 2 to 10 liters per second. In some embodiments, the flow rate through the inlet ranges from 3 to 9 liters per second. In some embodiments, the flow rate through the inlet ranges from 4 to 8 liters per second. In some embodiments, the flow rate through the inlet ranges from 5 to 7 liters per second.

In some embodiments, the water can be flowed from the inlet into a first deflocculation deflocculation tank. In some embodiments, water can be flowed from the first deflocculation tank into a second deflocculation tank. In some embodiments, water can be flowed from the second deflocculation tank into a third deflocculation tank. In some embodiments, water can be flowed from the third deflocculation tank into a fourth deflocculation tank. In some embodiments, water can be flowed from the fourth deflocculation tank into a fifth deflocculation tank. In some embodiments there are up to ten deflocculation tanks and water can be flowed from the fifth deflocculation tank, to the sixth deflocculation tank, to the seventh deflocculation tank, to the eighth deflocculation tank, to the ninth deflocculation tank, and to the tenth deflocculation tank, when present.

In some embodiments the flow rate between each deflocculation tank, when more than one deflocculation tank is present, ranges from 2 to 10 liters per second. In some embodiments the flow rate between each deflocculation tank, when more than one deflocculation tank is present, ranges from 3 to 9 liters per second. In some embodiments the flow rate between each deflocculation tank, when more than one deflocculation tank is present, ranges from 4 to 8 liters per second. In some embodiments the flow rate between each deflocculation tank, when more than one deflocculation tank is present, ranges from 5 to 7 liters per second.

In some embodiments, the volume of at least one of: the at least one deflocculation tank or the at least one sparging tank ranges from 0.25 million cubic inches to 5 million cubic inches. In some embodiments, the volume of at least one of: the at least one deflocculation tank or the at least one sparging tank ranges from 0.5 million cubic inches to 2.5 million cubic inches. the volume of at least one of: the at least one deflocculation tank or the at least one sparging tank ranges from 0.75 million cubic inches to 1.25 million cubic inches.

In some embodiments, at least one of: the at least one deflocculation tank or the at least one sparging tank holds from 350 to 7500 gallons of water. In some embodiments, at least one of: the at least one deflocculation tank or the at least one sparging tank holds from 700 to 5000 gallons of water. In some embodiments, at least one of: the at least one deflocculation tank or the at least one sparging tank holds from 1400 to 2500 gallons of water. In some embodiments, at least one of: the at least one deflocculation tank or the at least one sparging tank holds from 2100 to 2200 gallons of water.

In some embodiments, the concentrations of one or more contaminants described herein after the first deflocculation tank ranges from 50 to 55 mg per liter of water. In some embodiments, the concentrations of one or more contaminants described herein after the first deflocculation tank ranges from 51 to 54 mg per liter of water. In some embodiments, the concentrations of one or more contaminants described herein after the first deflocculation tank ranges from 52 to 53 mg per liter of water.

In some embodiments, the concentrations of one or more contaminants described herein after the second deflocculation tank ranges from 40 to 45 mg per liter of water. In some embodiments, the concentrations of one or more contaminants described herein after the second deflocculation tank ranges from 41 to 44 mg per liter of water. In some embodiments, the concentrations of one or more contaminants described herein after the second deflocculation tank ranges from 42 to 43 mg per liter of water.

In some embodiments, the concentrations of one or more contaminants described herein after the third deflocculation tank ranges from 30 to 35 mg per liter of water. In some embodiments, the concentrations of one or more contaminants described herein after the third deflocculation tank ranges from 31 to 34 mg per liter of water. In some embodiments, the concentrations of one or more contaminants described herein after the third deflocculation tank ranges from 32 to 33 mg per liter of water.

In some embodiments, when present, the second deflocculation tank can be disposed between the first deflocculation tank and the at least one sparging tank. In some embodiments, when present, the third deflocculation tank can be disposed between the second deflocculation tank and the at least one sparging tank. In some embodiments, when present, the fourth deflocculation tank can be disposed between the third deflocculation tank and the at least one sparging tank. In some embodiments, when present, the fifth deflocculation tank can be disposed between the fourth deflocculation tank and the at least one sparging tank. In some embodiments there are ten deflocculation tanks, such that the ninth tank can be disposed between the tenth deflocculation tank and the at least one sparging tank.

In some embodiments, treated water is flowed from the at least one sparging tank into an outlet.

In some embodiments, the flow rate through the outlet ranges from 2 to 10 liters per second. In some embodiments, the flow rate through the outlet ranges from 3 to 9 liters per second. In some embodiments, the flow rate through the outlet ranges from 4 to 8 liters per second. In some embodiments, the flow rate through the outlet ranges from 5 to 7 liters per second.

In some embodiments, the concentrations of one or more contaminants at the outlet ranges from 25 to 30 mg per liter of water. In some embodiments, the concentrations of one or more contaminants at the outlet ranges from 26 to 29 mg per liter of water. In some embodiments, the concentrations of one or more contaminants at the outlet ranges from 27 to 28 mg per liter of water.

Additional non-limiting examples of contaminants, their respective inlet concentrations, their respective outlet concentrations, and their respective percent reductions are provided in Table 1 below.

TABLE 1

| | | Outlet | |
|---|---|---|---|
| Exemplary | Inlet Concentration | Concentration | Percent |
| Contaminant | (mg/l) | (mg/l) | Reduction |
| Total Ammonia | 27.0 | 11.95 | 64% |
| Biochemical | 131 | 9 | 93% |
| Oxygen | | | |
| Carbonaceous | 74 | 6 | 86% |
| Biochemical Oxygen | | | |
| Chemical | 214 | 27 | 87% |
| Oxygen | | | |
| Phosphorus | 2.78 | 0.03 | 99% |
| (“P”) | | | |
| Total Suspended | 176 | 7.7 | 96% |
| Solids (“TSS”) | | | |
| Unionized Ammonia | 0.0793 | 0.0568 | 28% |
| Arsenic (As) | 0.00127 | 0.00069 | 54% |
| Beryllium (Be) | 0.005 | 0.0005 | 90% |
| Bismuth (Bi | 0.00033 | 0.00025 | 24% |
| Boron (B) | 0.726 | 0.058 | 92% |
| Cadmium (Cd) | 0.000040 | 0.000025 | 38% |
| Calcium (Ca) | 143 | 116 | 19% |
| Chromium (Cr) | 0.00068 | 0.0005 | 26% |
| Copper (Cu) | 0.0392 | 0.0025 | 94% |
| Iron (Fe) | 0.208 | 0.072 | 65% |
| Lead (Pb) | 0.00090 | 0.00025 | 72% |
| Magnesium (Mg) | 102 | 88.8 | 13% |
| Manganese (Mn) | 0.132 | 0.0769 | 42% |
| Potassium (K) | 19.5 | 17.8 | 9% |
| Phosphorus (P) | 342 | 0.30 | 99.9% |
| Rubidium (Rb) | 0.0093 | 0.0089 | 4% |
| Selenium (Se) | 0.00189 | 0.00025 | 87% |
| Silicon (Si) | 9.99 | 12.0 | 67% |
| Strontium (Sr) | 102 | 0.933 | 99% |
| Sulfur (S) | 356 | 313 | 12% |
| Tin (Sn) | 0.00096 | 0.0005 | 48% |
| Titanium (Ti) | 0.0035 | 0.0015 | 57% |
| Uranium (U) | 0.0282 | 0.0193 | 68% |
| Zirconium (Zr) | 0.00139 | 0.0003 | 78% |

In some embodiments, the first deflocculation tank comprises a first series of electrodes. In some embodiments, there is a second deflocculation tank comprising a second series of electrodes. In some embodiments, there is a third deflocculation tank comprising a third series of electrodes. In some embodiments, there is a fourth deflocculation tank comprising a fourth series of electrodes. In some embodiments, there is a fifth deflocculation tank comprising a fifth series of electrodes. In some embodiments, there are ten deflocculation tanks comprising ten series of electrodes.

In some embodiments, each series of electrodes each comprises an odd number of electrodes. In some embodiments, a first electrode of each series of electrodes is a cathode and a last electrode of each series of electrodes is a cathode. In some embodiments, a second electrode of each series of electrodes is an anode and a second to last electrode of each series of electrodes is an anode. In some embodiments, a third electrode of each series of electrodes is a cathode and a third to last electrode of each series of electrodes is a cathode.

In some embodiments, the first electrode is a cathode and is connected to a first voltage source, the second electrode is an anode and is grounded, the third electrode is a cathode and is connected to a second voltage source, the third to last electrode is a cathode and is connected to the first voltage source, the second to last electrode is an anode and is grounded, and the last electrode is a cathode and is connected to the second voltage source. In some embodiments, the first electrode is a cathode and is grounded, the second electrode is an anode and is connected to a first voltage source, the third electrode is a cathode and is grounded, the third to last electrode is a cathode and is grounded, the second to last electrode is an anode and is connected to the first voltage source, and the last electrode is a cathode and is grounded. In some embodiments, the first electrode is a cathode and is connected to a first voltage source, the second electrode is an anode and is grounded, the third electrode is a cathode and is connected to the first voltage source, the third to last electrode is a cathode and is connected to the first voltage source, the second to last electrode is an anode and is grounded, and the last electrode is a cathode and is connected to the first voltage source.

In some embodiments, each series of electrodes comprises an alternating series of electrodes in a triode configuration, wherein the triode configuration comprises one or more discrete subunits, wherein at least one of the one or more discrete subunits has the following configuration: cathode, anode, cathode. In some embodiments, each series of electrodes is an alternating series of electrodes in a triode configuration, wherein the triode configuration comprises multiple discrete subunits, such that the alternating series of electrodes within the triode configuration is arranged as follows: Subunit 1 (cathode, anode, cathode), Subunit 2 (cathode, anode, cathode) . . . Subunit N (cathode, anode, cathode). In some embodiments, N ranges from 33 to 165. In some embodiments, N ranges from 33 to 132. In some embodiments, N ranges from 33 to 99. In some embodiments, N ranges from 33 to 66. In some embodiments, N ranges from 66 to 165. In some embodiments, N ranges from 99 to 165. In some embodiments, N ranges from 132 to 165. In some embodiments, N ranges from 66 to 99. In some embodiments, N ranges from 99 to 132.

In some embodiments, there are 100 to 500 electrodes in each series. In some embodiments, there are 150 to 450 electrodes in each series. In some embodiments, there are 200 to 400 electrodes in each series. In some embodiments, there are 250 to 350 electrodes in each series. In some embodiments, there are 275 to 325 electrodes in each series. In some embodiments, there are 101 to 499 electrodes in each series. In some embodiments, there are 151 to 449 electrodes in each series. In some embodiments, there are 201 to 399 electrodes in each series. In some embodiments, there are 251 to 349 electrodes in each series. In some embodiments, there are 277 to 323 electrodes in each series. In some embodiments, there are 102 to 498 electrodes in each series. In some embodiments, there are 153 to 447 electrodes in each series. In some embodiments, there are 204 to 396 electrodes in each series. In some embodiments, there are 252 to 348 electrodes in each series. In some embodiments, there are 276 to 324 electrodes in each series. In some embodiments, there are 102 to 447 electrodes in each series. In some embodiments, there are 105 to 495 electrodes in each series. In some embodiments, there are 159 to 441 electrodes in each series. In some embodiments, there are 207 to 393 electrodes in each series. In some embodiments, there are 255 to 345 electrodes in each series. In some embodiments, there are 279 to 321 electrodes in each series.

In some embodiments, each of series of electrodes comprises an anode comprising at least one of: bare aluminum, anodized aluminum, rutile titanium(IV) oxide coated aluminum, aluminum (III) oxide coated aluminum, or combinations thereof.

In some embodiments, each series of electrodes comprises a cathode comprising at least one of: chromate replacement aluminum, oxygen treated rutile titanium (IV) coated aluminum, hot rolled aluminum, or combinations thereof.

In some embodiments, both the anode and the cathode are comprised of rutile titania (IV) oxide.

In some embodiments, the anode is coated with rutile titania (IV) oxide and the cathode is coated with oxygen treated rutile titania (IV) oxide.

In some embodiments, at least one of the anode or the cathode comprises at least one of: Aluminum, Manganese, Magnesium, Iron, Chromium, Copper, Zinc, Silicon, Titanium, Tin, Beryllium, or Zirconium.

In some embodiments, at least one of the anode or the cathode comprises Aluminum in an amount ranging from 89 to 99.2% by weight. In some embodiments, at least one of the anode or the cathode comprises Aluminum in an amount ranging from 92 to 98% by weight. In some embodiments, at least one of the anode or the cathode comprises Aluminum in an amount ranging from 93 to 97% by weight. Aluminum in an amount ranging from 94 to 96% by weight.

In some embodiments, at least one of the anode or the cathode comprises Manganese in an amount ranging from 0.20 to 1.00% by weight. In some embodiments, at least one of the anode or the cathode comprises Manganese in an amount ranging from 0.40 to 0.50% by weight.

In some embodiments, at least one of the anode or the cathode comprises Magnesium in an amount ranging from 0.60 to 4.4% by weight. In some embodiments, at least one of the anode or the cathode comprises Magnesium in an amount ranging from 1 to 2% by weight. In some embodiments, at least one of the anode or the cathode comprises Magnesium in an amount ranging from 1.5 to 1.75% by weight.

In some embodiments, at least one of the anode or the cathode comprises Iron in an amount ranging from 0.0 to 0.70% by weight. In some embodiments, at least one of the anode or the cathode comprises Iron in an amount ranging from 0.0 to 0.50% by weight. In some embodiments, at least one of the anode or the cathode comprises Iron in an amount ranging from 0.0 to 0.250% by weight.

In some embodiments, at least one of the anode or the cathode comprises Chromium in an amount ranging from 0.0 to 0.30% by weight. In some embodiments, at least one of the anode or the cathode comprises Chromium in an amount ranging from 0.0 to 0.20% by weight. In some embodiments, at least one of the anode or the cathode comprises Chromium in an amount ranging from 0.0 to 0.10% by weight.

In some embodiments, at least one of the anode or the cathode comprises Copper in an amount ranging from 0.10 to 2.3% by weight. In some embodiments, at least one of the anode or the cathode comprises Copper in an amount ranging from 0.25 to 1% by weight. In some embodiments, at least one of the anode or the cathode comprises Copper in an amount ranging from 0.5 to 0.75% by weight.

In some embodiments, at least one of the anode or the cathode comprises Zinc in an amount ranging from 0.0 to 6.2% by weight. In some embodiments, at least one of the anode or the cathode comprises Zinc in an amount ranging from 1 to 3% by weight. In some embodiments, at least one of the anode or the cathode comprises Zinc in an amount ranging from 2 to 2.5% by weight.

In some embodiments, at least one of the anode or the cathode comprises Silicon in an amount ranging from 0.25 to 1.5% by weight. In some embodiments, at least one of the anode or the cathode comprises Silicon in an amount ranging from 0.5 to 1.25% by weight. In some embodiments, at least one of the anode or the cathode comprises Silicon in an amount ranging from 0.75 to 1% by weight.

In some embodiments, at least one of the anode or the cathode comprises Titanium in an amount ranging from 0.0 to 0.20% by weight. In some embodiments, at least one of the anode or the cathode comprises Titanium in an amount ranging from 0.0 to 0.10% by weight.

In some embodiments, at least one of the anode or the cathode comprises Beryllium in an amount ranging from 0 to 0.00080% by weight. In some embodiments, at least one of the anode or the cathode comprises Beryllium in an amount ranging from 0 to 0.00040% by weight. In some embodiments, at least one of the anode or the cathode comprises Beryllium in an amount ranging from 0 to 0.00020% by weight.

In some embodiments, at least one of the anode or the cathode comprises Zirconium in an amount ranging from 0 to 0.12% by weight. In some embodiments, at least one of the anode or the cathode comprises Zirconium in an amount ranging from 0 to 0.06% by weight. In some embodiments, at least one of the anode or the cathode comprises Zirconium in an amount ranging from 0 to 0.03% by weight.

Additional exemplary, non-limiting compositions of electrodes that can be used in the systems and methods described herein are set forth below in Tables 2-13.

TABLE 2

| Element | Content (%) |
|---|---|
| Manganese (Mn) | 0.20-1.00 |
| Magnesium, Mg | 0.60-1.20 |
| Iron, Fe | 0.0-0.70 |
| Chromium, Cr | 0.0-0.30 |
| Copper, Cu | 0.20-0.50 |
| Zinc, Zn | 0.0-0.30 |
| Silicon (Si) | 0.60-1.40 |
| Titanium (Ti) | 0.0-0.20 |
| Tin (Sn) | 0.0-0.05 |

TABLE 3

| Element | Content (%) |
|---|---|
| Aluminum, Al | 97.9 |
| Magnesium, Mg | 1 |
| Silicon, Si | 0.6 |
| Copper, Cu | 0.28 |
| Chromium, Cr | 0.2 |

TABLE 4

| Element | Content (%) |
|---|---|
| Manganese (Mn) | 0.20-1.00 |
| Magnesium, Mg | 0.60-1.20 |
| Iron, Fe | 0.0-0.70 |
| Chromium, Cr | 0.0-0.30 |
| Copper, Cu | 0.20-0.50 |
| Zinc, Zn | 0.0-0.30 |
| Silicon (Si) | 0.60-1.40 |
| Titanium (Ti) | 0.0-0.20 |
| Tin (Sn) | 0.0-0.05 |
| Other (each) | 0.0-0.05 |

TABLE 5

| Element | Content (%) |
|---|---|
| Manganese (Mn) | 0.20-1.00 |
| Magnesium, Mg | 0.60-1.20 |
| Iron, Fe | 0.0-0.70 |
| Chromium, Cr | 0.0-0.30 |
| Copper, Cu | 0.20-0.50 |
| Zinc, Zn | 0.0-0.30 |
| Silicon (Si) | 0.60-1.40 |
| Titanium (Ti) | 0.0-0.20 |
| Tin (Sn) | 0.0-0.05 |
| Other (each) | 0.0-0.05 |

TABLE 6

| Element | Content (%) |
|---|---|
| Aluminum, Al | 99.2 |
| Magnesium, Mg | 0.8 |

TABLE 7

| Element | Content (%) |
|---|---|
| Aluminum, Al | 97.2 |
| Magnesium, Mg | 2.5 |
| Chromium, Cr | 0.25 |

TABLE 8

| Element | Content (%) |
|---|---|
| Aluminum, Al | 94.7 |
| Magnesium, Mg | 4.4 |
| Chromium, Cr | 0.15 |
| Manganese, Mn | 0.7 |

TABLE 9

| Element | Content (%) |
|---|---|
| Al | 95.4 |
| Mg | 4 |
| Cr | 0.15 |
| Mn | 0.4 |

TABLE 10

| Element | Content (%) |
|---|---|
| Aluminum, Al | 94.6-97 |
| Magnesium, Mg | 2.4-3 |
| Manganese, Mn | 0.50-1 |
| Iron, Fe | ≤0.40 |
| Zinc, Zn | ≤0.25 |
| Silicon, Si | ≤0.25 |
| Copper, Cu | ≤0.10 |
| Chromium, Cr | 0.050-0.20 |
| Titanium, Ti | 0.050-0.20 |
| Beryllium, Be | ≤0.00080 |

TABLE 11

| Element | Content (%) |
|---|---|
| Aluminum, Al | 89 |
| Copper, Cu | 2.3 |
| Magnesium, Mg | 2.3 |
| Zinc, Zn | 6.2 |
| Zirconium, Zr | 0.12 |

TABLE 12

| Element | Content (%) |
|---|---|
| Aluminum, Al | 90 |
| Zinc, Zn | 5.6 |
| Magnesium, Mg | 2.5 |
| Copper, Cu | 1.6 |
| Chromium, Cr | 0.23 |

TABLE 13

| Element | Content (%) |
|---|---|
| Aluminum, Al | 90.3 |
| Zinc, Zn | 5.7 |
| Magnesium, Mg | 2.3 |
| Silicon, Si | 1.5 |
| Chromium, Cr | 0.22 |

In some embodiments, the first deflocculation tank comprises a first bubbler. In some embodiments, there is a second deflocculation tank comprising a second bubbler. In some embodiments, there is a third deflocculation tank comprising a third bubbler. In some embodiments, there is a fourth deflocculation tank comprising a fourth bubbler. In some embodiments, there is a fifth deflocculation tank comprising a fifth bubbler. In some embodiments, there is a tenth deflocculation tank comprising a tenth bubbler.

In some embodiments, at least one bubbler is a Point Four™ Micro Bubble Diffuser manufactured by PentAir.

In some embodiments, each bubbler is configured to expel one or more cleaning agents comprising chlorine gas, oxygen gas, carbon dioxide gas, ammonia gas, or nitrogen trifluoride gas into the water. In some embodiments, the bubblers clean the electrodes in situ and improve flocculation. In some embodiments, each bubbler increases the rate of particle removal. In some embodiments, the bubblers are configured to control the pH of the water. In some embodiments, the bubblers are configured to remove dissolved gasses. In some embodiments, the bubblers are configured to reduce ammonium hydroxide concentration in the water. In some embodiments, the flow of the one or more cleaning agents is controlled using a mass flow controller. In some embodiments, the pH of the water from the inlet is monitored. In some embodiments, the bubblers are configured to allow for the flotation of contaminants within the deflocculation tanks.

In some embodiments, one or more bubblers can extend across a bottom portion of each deflocculation tank or can extend across a bottom portion of multiple deflocculation tanks. In some embodiments, a single bubbler that extends across the entire system and is disposed at the bottom of each deflocculation tank is provided. In some embodiments, one or more bubblers comprise a sintered component. In some embodiments, the sintered component comprises at least one of: brass, stainless steel, sintered nickel, or sintered alumina.

In some embodiments, the bubbler comprises a plurality of pores configured to expel one or more cleaning agents. In some embodiments, the plurality of pores has a size ranging from 0.02 mm to 3 mm. In some embodiments, the plurality of pores has a size ranging from 0.04 mm to 1.5 mm. In some embodiments, the plurality of pores has a size ranging from 0.08 mm to 0.75 mm. In some embodiments, the plurality of pores has a size ranging from 0.16 mm to 0.3 mm.

In some embodiments, the plurality of pores are disposed 360° around an outer surface of the bubbler. In some embodiments, the plurality of pores are disposed 180° around an outer surface of the bubbler. In some embodiments, the plurality of pores are disposed 90° around an outer surface of the bubbler. In some embodiments, the plurality of pores are disposed around an outer surface of the bubbler.

In some embodiments, there is a gradual decrease in pore size across the system. For example, the pores closest to the inlet can have a size of 3 mm, while the pores closest to the outlet can have an average size of 0.02 mm. In some embodiments, the pores closest to the inlet can have a size of 1.5 mm, while the pores closest to the outlet can have an average size of 0.04 mm. In some embodiments, the pores closest to the inlet can have a size of 0.75 mm, while the pores closest to the outlet can have an average size of 0.08 mm. In some embodiments, the pores closest to the inlet can have a size of 0.3 mm, while the pores closest to the outlet can have an average size of 0.16 mm. In some embodiments, the gradual decrease is a linear decrease. In some embodiments, the decrease is non-linear decrease, such as a negative exponential or hyperbolic decrease.

In some embodiments one or more cleaning agents are expelled into the water with one or more bubblers. In some embodiments, the one or more cleaning agents comprise at least one of: chlorine gas, oxygen gas, air, carbon dioxide gas, ammonia gas, nitrogen trifluoride gas, or combinations thereof.

In some embodiments, the oxygen gas is hot oxygen gas at 30-50 Degrees Celsius. In some embodiments, the oxygen gas is hot oxygen gas at 40-50 Degrees Celsius. In some embodiments, the oxygen gas is hot oxygen gas at 45-50 Degrees In some embodiments, the oxygen is hot oxygen gas at 30-40 Degrees Celsius. In some embodiments, the oxygen is hot oxygen gas at 30-45 Degrees Celsius.

In some embodiments, the air is hot air at 30-50 Degrees Celsius. In some embodiments, the air is hot air at 40-50 Degrees Celsius. In some embodiments, the air gas is hot air at 45-50 Degrees Celsius. In some embodiments, the air is hot air at 30-40 Degrees Celsius. In some embodiments, the air is hot air at 30-45 Degrees Celsius.

In some embodiments, the concentration of a chlorine gas cleaning agent ranges from 10 to 500 standard cubic centimeters per minute. In some embodiments, the concentration of a chlorine gas cleaning agent ranges from 20 to 250 standard cubic centimeters per minute. In some embodiments, the concentration of a chlorine gas cleaning agent ranges from 40 to 100 standard cubic centimeters per minute. In some embodiments, the concentration of a chlorine gas cleaning agent ranges from 50 to 80 standard cubic centimeters per minute.

In some embodiments, the concentration of a hot oxygen cleaning agent ranges from 10 to 1000 standard cubic centimeters per minute. In some embodiments, the concentration of a hot oxygen cleaning agent ranges from 20 to 500 standard cubic centimeters per minute. In some embodiments, the concentration of a hot oxygen cleaning agent ranges from 40 to 250 standard cubic centimeters per minute. In some embodiments, the concentration of a hot oxygen cleaning agent ranges from 80 to 100 standard cubic centimeters per minute.

In some embodiments, the concentration of a hot air cleaning agent ranges from 10 to 1000 standard cubic centimeters per minute. In some embodiments, the concentration of a hot air cleaning agent ranges from 20 to 500 standard cubic centimeters per minute. In some embodiments, the concentration of a hot air cleaning agent ranges from 40 to 250 standard cubic centimeters per minute. In some embodiments, the concentration of a hot air cleaning agent ranges from 80 to 100 standard cubic centimeters per minute.

In some embodiments, the one or more cleaning agents forms a plurality of bubbles, wherein each bubble has an average size ranging from 0.5 to 5 mm. In some embodiments each bubble has an average size ranging from 0.6 to 4 mm. In some embodiments each bubble has an average size ranging from 0.7 to 3 mm. In some embodiments each bubble has an average size ranging from 0.8 to 2 mm. In some embodiments each bubble has an average size ranging from 0.9 to 1 mm.

In some embodiments, a regulated power supply is configured to generate flocculating metal ions from at least one metal contaminant. In some embodiments, the flocculating metal ions grow as a function of total current applied to the system, but do not grow as a function of the current per unit volume of water. In some embodiments, the time for formation of flocculating metal ions ranges from 0.3 seconds to 2 seconds.

In some embodiments, the regulated power supply applies at least one electric potential to the first series of electrodes. In some embodiments, the at least one electric potential is applied to at least one of: the first series of electrodes or the second series of electrodes. In some embodiments, the at least one electric potential is applied to at least one of: the first series of electrodes, the second series of electrodes, or the third series of electrodes. In some embodiments, the at least one electric potential is applied to one, some, or all of the electrodes.

In some embodiments, the voltage applied to each electrode ranges from 5 to 96 V of direct current. In some embodiments, the voltage applied to each electrode ranges from 10 to 50V of direct current. In some embodiments, the voltage applied to each electrode ranges from 15 to 45V of direct current. In some embodiments, the voltage applied to each electrode ranges from 20 to 40V of direct current. In some embodiments, the voltage applied to each electrode ranges from 25 to 35V of direct current.

In some embodiments, the power applied to each electrode ranges from 1.5 to 300 W. In some embodiments, the power applied to each electrode ranges from 3 to 150 W. In some embodiments, the power applied to each electrode ranges from 6 to 75 W. In some embodiments, the power applied to each electrode ranges from 12 to 50 W.

In some embodiments, the operating voltage of the systems and methods described herein ranges from 5 to 96 V of direct current. In some embodiments, the operating voltage of the systems and methods described herein ranges from 10 to 50 V of direct current. In some embodiments, the operating voltage of the systems and methods described herein ranges from 15 to 45 V of direct current. In some embodiments, the operating voltage of the systems and methods described herein ranges from 20 to 40 V of direct current. In some embodiments, the operating voltage of the systems and methods described herein ranges from 25 to 35 V of direct current.

In some embodiments, the operating power of the systems and methods described herein ranges from 500 W to 200,000 W. In some embodiments, the operating power of the systems and methods described herein ranges from 1000 W to 100,000 W. In some embodiments, the operating power of the systems and methods described herein ranges from 2500 W to 50,000 W. In some embodiments, the operating power of the systems and methods described herein ranges from 5000 W to 25,000 W. In some embodiments, the operating power of the systems and methods described herein ranges from 10,000 W to 25,000 W.

In some embodiments, a control system is configured to vary the at least one electric potential to provide a predetermined fixed current to the first deflocculation tank. In some embodiments, the at least one electric potential provides a predetermined fixed current to at least one of: the first deflocculation tank or the second deflocculation tank. In some embodiments, the at least one electric potential provides a predetermined fixed current to at least one of: the first deflocculation tank, the second deflocculation tank, or the third deflocculation tank. In some embodiments, the at least one electric potential provides a predetermined fixed current to at least one of: the first deflocculation tank, the second deflocculation tank, the third deflocculation tank, the fourth deflocculation tank, the fifth deflocculation tank, the sixth deflocculation tank, the seventh deflocculation tank, the eighth deflocculation tank, the ninth deflocculation tank, or the tenth deflocculation tank. In some embodiments, the at least one electric potential provides a predetermined fixed current to at least one electrode.

In some embodiments, the predetermined fixed current is from is a voltage limited current that does not vary as a function of the flow rate of water. In some embodiments, the voltage limited current ranges from 50-160 amps of direct current. In some embodiments, the voltage limited current ranges from 50-120 amps of direct current. In some embodiments, the voltage limited current ranges from 50-80 amps of direct current. In some embodiments, the voltage limited current ranges from 50-60 amps of direct current. In some embodiments, the voltage limited current ranges from 60-160 amps of direct current. In some embodiments, the voltage limited current ranges from 80-160 amps of direct current. In some embodiments, the voltage limited current ranges from 120-160 amps of direct current. In some embodiments, the voltage limited current ranges from 60-120 amps of direct current. In some embodiments, the voltage limited current ranges from 80-120 amps of direct current. In some embodiments, the voltage limited current ranges from 60-80 amps of direct current.

In some embodiments, the control system comprises a programmable logic controller (PLC). In some embodiments, the control system is connected to the systems described herein by at least one of: DC power connections, analog connections, or digital connections. In some embodiments, the control system is an Ethernet IP Network with both deterministic and non-deterministic comment sets. In some embodiments, the control system includes a network of microcontrollers and a PC HMI system.

In some embodiments the, flocculated metal ions are collected from at least one of the deflocculation tanks, so as to obtain deflocculated water. In some embodiments, the flocculated metal ions are removed by bubbles which capture the flocculated metal ions and carry them to the surface. In some embodiments, the bubbles that carry the flocculated metal ions to the surface are formed by at least one of: in situ electrolytic oxidation of the anode material, or injection of cleaning agents by the bubblers described herein. In some embodiments, the flocculated metal ions float to an upper portion of at least one deflocculation tank where they are skimmed off by at least one of an air knife, low frequency (e.g, 3-10 Hz, 4-9 Hz, 5-8 Hz, 6-7 Hz) turbulence, or a comb structure. In some embodiments, the air knife is a Conada air knife. In some embodiments, the flocculated metal ions sink to the bottom of at least one deflocculation tank and are drawn out by a drain.

In some embodiments, 80% of the flocculated metal ions are skimmed off and 20% of the flocculated metal ions are drawn out by a drain. In some embodiments, 70% of the flocculated metal ions are skimmed off and 30% of the flocculated metal ions are drawn out by a drain.

In some embodiments, the deflocculated water is flowed into at least one sparging tank. In some embodiments, there are a plurality of sparging tanks. In some embodiments, there are two sparging tanks. In some embodiments, there are three sparging tanks. In some embodiments, there are four sparging tanks. In some embodiments, there are five sparging tanks. In some embodiments, there are six sparging tanks. In some embodiments, there are seven sparging tanks. In some embodiments, there are eight sparging tanks. In some embodiments, there are nine sparging tanks. In some embodiments, there are ten sparging tanks

In some embodiments, the sparging tank comprises a sparger. In some embodiments, the sparger is configured to remove one or more non-metal contaminants from the deflocculated water to obtain treated water. In some embodiments, the sparger is a gas phase treatment sparger comprising a first proximal end immersed in the water in the sparging tank and a second distal end connected to a vacuum source.

In some embodiments, the vacuum source provides a pressure at the distal end of the sparger that ranges from 1 to 10 torr. In some embodiments, the vacuum source provides a pressure at the distal end of the sparger that ranges from 2 to 9 torr. In some embodiments, the vacuum source provides a pressure at the distal end of the sparger that ranges from 3 to 8 torr. In some embodiments, the vacuum source provides a pressure at the distal end of the sparger that ranges from 4 to 7 torr. In some embodiments, the vacuum source provides a pressure at the distal end of the sparger that ranges from 5 to 6 torr.

In some embodiments, the sparger comprises at least one of sintered nickel or alumina.

In some embodiments, the sparger has a pore size ranging from 0.5 to 3 microns. In some embodiments, the sparger has a pore size ranging from 0.75 to 2 microns. In some embodiments, the sparger has a pore size ranging from 1 to 1.5 microns.

In some embodiments, the systems and methods described herein have an operating temperature range of from 0 to 40° C. In some embodiments, the systems and methods described herein have an operating temperature range of from 5 to 30° C. In some embodiments, the systems and methods described herein have an operating temperature range of from 10 to 20° C.

In some embodiments, the systems and methods described herein have an operating pressure range of from 16-32 psia. In some embodiments, the systems and methods described herein have an operating pressure range of from 20-28 psia. In some embodiments, the systems and methods described herein have an operating pressure range of from 22-26 psia. In some embodiments, the systems and methods described herein have an operating pressure range of from 23-25 psia.

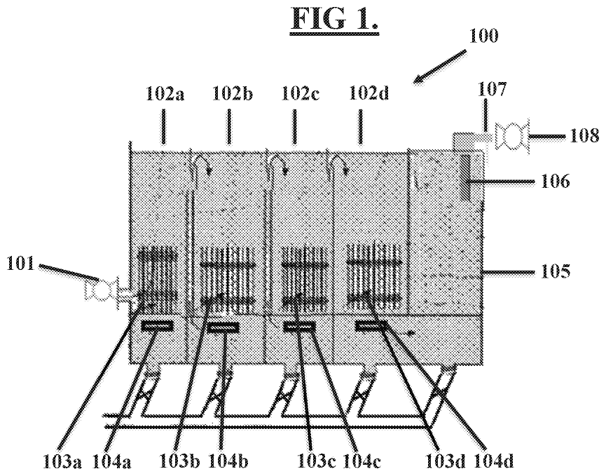

FIG. 1 depicts an exemplary water purification system 100 and method in accordance with the present disclosure. As shown, water travels from inlet 101 into deflocculation tank 102a, which comprises a series of electrodes 103a and a bubbler 104a. Water then travels from deflocculation tank 102a into deflocculation tank 102b, which comprises a series of electrodes 103b and a bubbler 104b. Water then travels from deflocculation tank 102b into deflocculation tank 102c, which comprises a series of electrodes 103c and a bubbler 104c. Water then travels from deflocculation tank 102c into deflocculation tank 102d, which comprises a series of electrodes 103d and a bubbler 104d. Water then travels from deflocculation tank 102d into sparging tank 105, which comprises sparger 106 connected to vacuum 107. Treated water then travels from sparging tank 105 into outlet 108.

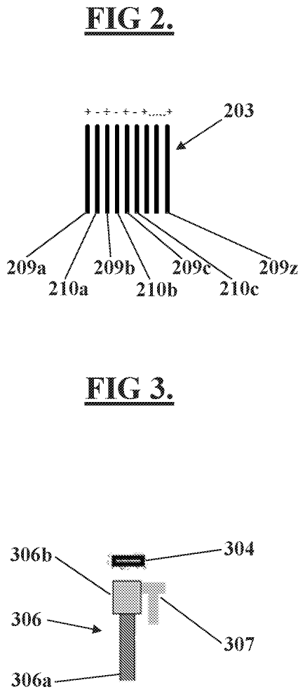

FIG. 2 depicts an exemplary series of electrodes 203 in accordance with the present disclosure. As shown, the series of electrodes 203 is in a triode configuration. In particular, the series of electrodes 203 comprises an odd number of electrodes with the first and last electrode of the series of electrodes 203 being a cathode 209. As shown, the cathodes 209 and the anodes 210 of the series of electrodes 203 are in an alternating configuration. In particular, the series of electrodes 203 comprises a first cathode 209a, followed by a first anode 210a, followed by a second cathode 209b, followed by a second anode 209b, followed by a third cathode 209c, followed by a third anode 210c. The series terminates with a third to last cathode (not shown), a third to last anode (not shown), and a final cathode 209z.

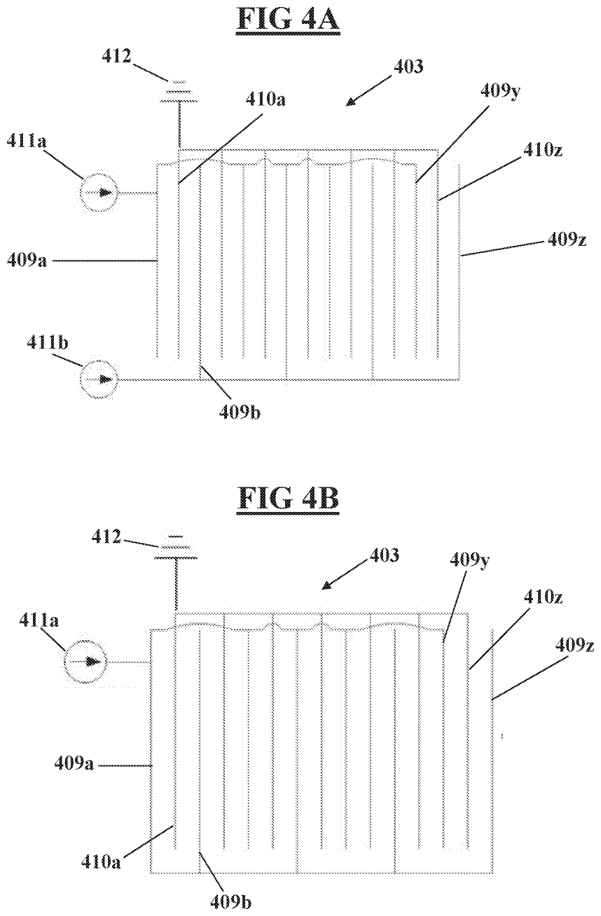

FIG. 3 depicts an exemplary bubbler 304, sparger 306, and vacuum 307 in accordance with the present disclosure. As shown, the sparger 306 comprises a proximal end 306a configured to be inserted into one or more of the deflocculation tanks 102. The sparger 306 further comprises a distal end 306b connected to vacuum source 307.

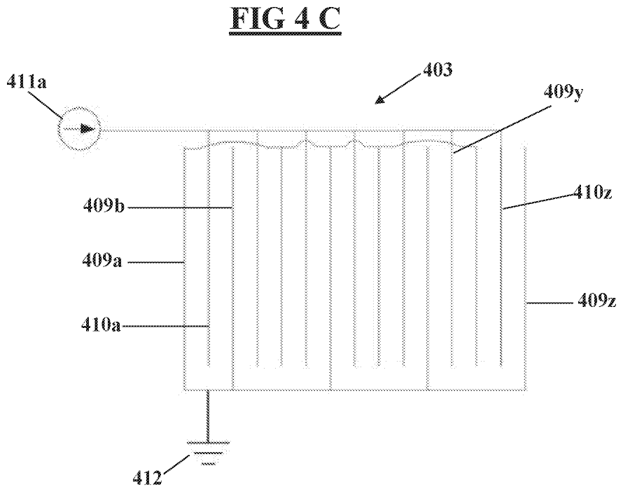

FIG. 4A depicts a circuit diagram showing a first exemplary configuration of electrodes 403 in accordance with the present disclosure. As shown, the first electrode is a cathode 409a and is connected to a first voltage source 411a, the second electrode is an anode 410a and is connected to ground 412, the third electrode is a cathode 409b and is connected to a second voltage source, the third to last electrode is cathode 409y and is connected to the first voltage source 411a, the second to last electrode is an anode 410z and is grounded, and the last electrode is a cathode 409z and is connected to the second voltage source 411b.

FIG. 4B depicts a circuit diagram showing a second exemplary configuration of electrodes 403 in accordance with the present disclosure. As shown, the first electrode is a cathode 409a and is connected to a first voltage source 411a, the second electrode is an anode 410a and is connected to ground 412, the third electrode is a cathode 409b and is connected to the first voltage source 411a, the third to last electrode is a cathode 409y and is connected to the first voltage source 411a, the second to last electrode is an anode 410z and is connected to ground 412, and the last electrode is a cathode 409z and is connected to the first voltage source 411a.

FIG. 4C depicts a circuit diagram showing a third exemplary configuration of electrodes 403 in accordance with the present disclosure. As shown, the first electrode is a cathode 409a and is connected to ground 412, the second electrode is an anode 410a and is connected to a first voltage source 411a, the third electrode is a cathode 409b and is connected to ground 412, the third to last electrode is a cathode 409y and is connected to ground 412, the second to last electrode is an anode 410z and is connected to the first voltage source 411a, and the last electrode is a cathode and is connected to ground 412.

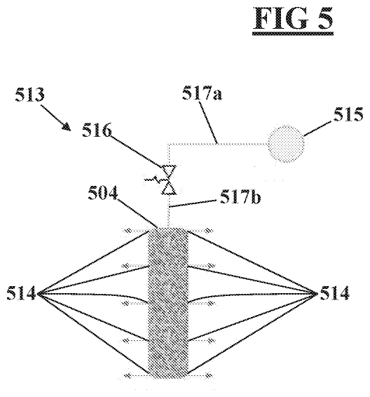

FIG. 5 depicts an exemplary bubbler assembly in accordance with the present disclosure. As shown, the bubbler assembly 513 comprises a bubbler 504, a gas source 515 and a mass flow controller 516. The bubbler 504 can comprise any suitable material, such as the sintered materials described herein (e.g., brass, stainless steel or sintered alumina). The bubbler 504 can also comprise a plurality of pores 514, which can be configured to output one or more gases into at least one of the plurality of deflocculation tanks (not shown) or the sparging tank (not shown). The one or more gases can be transported from the gas source 515 to a mass flow controller 516 by a first conduit 517a and into the bubbler 504b by a second conduit 517b. The first and second conduits 517a and 517b can be any suitable flow transport medium such as a valve, a drain, a pipe, etc. The one or more gases can be any suitable gas described herein (e.g., air, chlorine, oxygen, helium, etc.) The mass flow controller 516 can be configured to regulate the flow of the one or more gases from the gas source 515 to the bubbler 504 so that a desired amount of the one or more gases can be output into at least one of the plurality of deflocculation tanks (not shown) or the sparging tank (not shown).

Variations, modifications and alterations to the preferred embodiment of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

It is envisioned that any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A method comprising:
obtaining water, the water comprising one or more contaminants;
flowing the water from an inlet into a first deflocculation tank, the first deflocculation tank comprising:
a first series of electrodes; and
a first bubbler;
generating flocculating metal ions from at least one metal contaminant with a regulated power supply by:
applying, with a regulated power supply, at least one electric potential to the first series of electrodes; and
varying, with a control system, the at least one electric potential to provide a predetermined fixed current to the first deflocculation tank,
wherein the predetermined fixed current does not vary as a function of flow rate;
collecting the flocculated metal ions from the first deflocculation tank, so as to obtain deflocculated water;
flowing the deflocculated water into at least one sparging tank,
wherein the at least one sparging tank comprises a sparger;
removing, with the sparger, at least one non-metal contaminant from the deflocculated water to obtain treated water; and
flowing the treated water into an outlet.

2. The method of claim 1, further comprising steps of:
flowing the water from the first deflocculation tank into a second deflocculation tank,
wherein the second deflocculation tank is disposed between the first deflocculation tank and the at least one sparging tank;
wherein the second deflocculation tank comprises a second series of electrodes and a second bubbler; and
generating flocculating metal ions from at least one metal contaminant with a regulated power supply by:
applying, with the regulated power supply, at least one electric potential to at least one of: the first series of electrodes or the second series of electrodes; and
varying, with a control system, the at least one electric potential to provide a predetermined fixed current to at least one of: the first deflocculation tank or the second deflocculation tank,
collecting the flocculated metal ions from at least one of the first deflocculation tank or the second deflocculation tank, so as to obtain deflocculated water.

3. The method of claim 2, further comprising steps of:
flowing the water from the second deflocculation tank into a third deflocculation tank,
wherein the third deflocculation tank is disposed between the second deflocculation tank and the at least one sparging tank;
wherein the third deflocculation tank comprises a third series of electrodes, and a third bubbler; and
generating flocculating metal ions with a regulated power supply by:
applying, with the regulated power supply, at least one electric potential to at least one of: the first series of electrodes, the second series of electrodes, or the third series of electrodes;
varying, with a control system, the at least one electric potential to provide a predetermined fixed current to at least one of: the first deflocculation tank, the second deflocculation tank, or the third deflocculation tank;
collecting the flocculated metal ions from at least one of: the first deflocculation tank, the second deflocculation tank, or the third deflocculation tank, so as to obtain deflocculated water.

4. The method of claim 1, further comprising a step of, expelling, with the first bubbler, one or more cleaning agents into the water, wherein the one or more cleaning agents comprise at least one of: chlorine gas, oxygen gas, carbon dioxide gas, ammonia gas, nitrogen trifluoride gas, or combinations thereof.

5. The method of claim 4 further comprising a step of, forming a plurality of bubbles with the one or more cleaning agents.

6. A system comprising:
an inlet;
a first deflocculation tank, the first deflocculation tank comprising:
a first series of electrodes; and
a first bubbler;
a regulated power supply;
wherein the regulated power supply is configured to generate flocculating metal ions;
wherein the regulated power supply is further configured to apply at least one electric potential to the first series of electrodes;
a control system,
wherein the control system is configured to vary the at least one electric potential to provide a predetermined fixed current to the first deflocculation tank,
wherein the predetermined fixed current does not vary as a function of flow rate;
at least one sparging tank comprising a sparger; and
an outlet.

7. The system of claim 6, wherein each series of electrodes comprises an odd number of electrodes.

8. The system of claim 6, wherein a first electrode of each series of electrodes is a cathode and a last electrode of each series of electrodes is a cathode.

9. The system of claim 6, wherein a second electrode of each series of electrodes is an anode and a second to last electrode of each series of electrodes is an anode.

10. The system of claim 6, wherein a third electrode of each series of electrodes is a cathode and a third to last electrode of each series of electrodes is a cathode.

11. The system of claim 6, wherein each series of electrodes comprises an anode comprising at least one of: bare aluminum, anodized aluminum, rutile titanium(IV) oxide coated aluminum, aluminum (III) oxide coated aluminum, or combinations thereof.

12. The system of claim 6, wherein each series of electrodes comprises a cathode comprising at least one of: chromate replacement aluminum, oxygen treated rutile titanium (IV) coated aluminum, hot rolled aluminum, or combinations thereof.

13. The system of claim 6, wherein the first electrode is a cathode and is connected to a first voltage source, the second electrode is an anode and is grounded, the third electrode is a cathode and is connected to a second voltage source, the third to last electrode is a cathode and is connected to the first voltage source, the second to last electrode is an anode and is grounded, and the last electrode is a cathode and is connected to the second voltage source.

14. The system of claim 6, wherein the first electrode is a cathode and is grounded, the second electrode is an anode and is connected to a first voltage source, the third electrode is a cathode and is grounded, the third to last electrode is a cathode and is grounded, the second to last electrode is an anode and is connected to the first voltage source, and the last electrode is a cathode and is grounded.

15. The system of claim 6 wherein the first electrode is a cathode and is connected to a first voltage source, the second electrode is an anode and is grounded, the third electrode is a cathode and is connected to the first voltage source, the third to last electrode is a cathode and is connected to the first voltage source, the second to last electrode is an anode and is grounded, and the last electrode is a cathode and is connected to the first voltage source.

16. The system of claim 6, wherein each series of electrodes is an alternating series of electrodes in a triode configuration, wherein the triode configuration comprises one or more discrete subunits, wherein each of the one or more discrete subunits has the following configuration: cathode, anode, cathode.

17. The system of claim 16, wherein the triode configuration comprises a plurality of discrete subunits, such that the alternating series of electrodes within the triode configuration is arranged as follows: cathode, anode, cathode . . . cathode, anode, cathode.

18. The system of claim 17, wherein there are from 33 to 165 discrete subunits.

19. The system of claim 6, wherein the predetermined fixed current ranges from 50 to 160 amps of direct current.

20. The system of claim 6, wherein the sparger is a gas phase treatment sparger comprising a first proximal end immersed in the water in the at least one sparging tank and a second distal end connected to a vacuum source.
